(19) United States
(12) Patent Application Publication
(10) Pub. No.: US 2008/0156863 A1
(43) Pub. Date: Jul. 3, 2008

(54) SYSTEMS AND METHODS FOR IMPROVING THE READABILITY OF PRINTED BAR CODE SYMBOLS AND THE LIKE

(75) Inventor: Timothy J Abrott, Normandy Park, WA (US)

Correspondence Address: WEYERHAEUSER COMPANY;INTELLECTUAL PROPERTY DEPT., CH 1J27, P.O. BOX 9777, FEDERAL WAY, WA, 98063, US

(73) Assignee: Weyerhaeuser Co., Federal Way, WA (US)

(21) Appl. No.: 11/618,199

(22) Filed: Dec. 29, 2006

(51) Int. Cl. G06K 7/10

(52) U.S. Cl. 235/375; 235/462.41

(57) ABSTRACT

Systems and methods are disclosed herein for improving the readability of printed bar code symbols. The system may include a print station for printing at least one bar code symbol onto a selected substrate, an optional bar code symbol reader for determining whether the printed bar code symbol is readable, an image capture device for capturing a digital image of the printed bar code symbol, an ink removal station having a laser for removing a portion of the printed bar code symbol, and a computing system. The computing system includes an image analysis module for analyzing the images captured by the image capture device. Based on the results of the analysis of the captured image, the system improves the readability of the printed bar code symbol by removing ink from the printed bar code symbol representative of potential deficiencies caused, in part, by the printing methods employed.

### BACKGROUND

Containers and displays for transporting and displaying goods have been utilized for many years. Such products are typically constructed from a suitable blank made from an appropriate substrate sheet, such as corrugated fiberboard. As generally known in the art, the blank is processed from a sheet of appropriate substrate stock to include panels, flaps, etc. hingedly connected to one another via score lines. The blank is then folded along these score lines and glued to form the final container product for the shipment of goods, point of sale displays, and the like.

In recent years, bar code symbols have been printed onto the blanks prior to or during the processing thereof. Bar codes symbols, which can be either one-dimensional or two-dimensional, can be utilized for such purposes as inventory management, tracking, point of sale promotions, etc. One-dimensional bar code symbols are a method of encoding numbers and letters by using a combination of bars and spaces of varying widths. Two-dimensional bar code symbols use a matrix of printed and unprinted rectangular areas for encoding. Bar code symbols are typically read by conventional scanning equipment that scans the bar code symbol and decodes the information contained therein, such as numbers and/or letters. The information contained in the bar code symbol is then matched to a particular manufacturer, product or other information by an associated computer system.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with aspects of the present invention, a method for improving the readability of a printed bar code symbol is provided. The method comprises printing a bar code symbol onto a substrate, capturing an image of the printed bar code symbol, analyzing the captured image of the printed bar code symbol for determining printing errors, and removing at least a portion of the printing errors from the substrate.

In accordance with another aspect of the present invention, a method for improving the readability of a printed bar code symbol is provided. The method comprises capturing an image of a printed bar code symbol, analyzing the captured image of the printed bar code symbol for determining printing errors, and removing at least a portion of the printing errors from the substrate.

In accordance with another aspect of the present invention, a system for improving the readability of a printed bar code symbol is provided. The system comprises an image capture device capable of capturing a digital image of a printed bar code symbol from a substrate, a laser capable of removing a portion of the printed bar code symbol, and a computing system. The computing system is capable of (1) receiving the captured image of the bar code symbol; (2) comparing the image to a reference bar code symbol image or a reference bar code symbol specification for determining the differences therebetween; and (3) outputting suitable signals to the laser for operating the laser to remove a portion of the printed bar code symbol associated with the differences previously determined.

### DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is a block diagram of an exemplary embodiment of a system for improving the readability of printed bar code symbols constructed in accordance with aspects of the present invention;

FIG. 2 is a block diagram of one exemplary embodiment of a computing system suitable for use in the system of FIG. 1;

FIG. 3 is a top view of an exemplary substrate on which a representative embodiment of a one-dimensional bar code symbol is printed;

FIG. 3A is a top view of a reference bar code symbol corresponding to the bar code symbol of FIG. 3;

FIG. 3B is a top view of the printed bar code symbol of FIG. 3;

FIG. 3C is a top view of data stored in an exemplary mask file depicting the differences when comparing the printed bar code symbol of FIG. 3B to the reference bar code symbol of FIG. 3A;

FIG. 4 is an exemplary embodiment of a process for improving the readability of printed bar code symbols;

FIG. 5 is an exemplary embodiment of an image analysis routine suitable for use by the process of FIG. 4; and

FIG. 6 is another exemplary embodiment of an image analysis routine suitable for use by the process of FIG. 4.

### DETAILED DESCRIPTION

Embodiments of the present invention will now be described with reference to the drawings where like numerals correspond to like elements. Embodiments of the present invention are directed to systems and methods for improving the readability of printed bar code symbols, such as one dimensional and two dimensional bar code symbols, used in the packaging industry. The following description provides examples of systems and methods that utilize a laser for improving the readability of printed bar code symbols. It should be apparent that the examples described below are only illustrative in nature, and therefore, such examples should not be considered as limiting the scope of the present invention, as claimed.

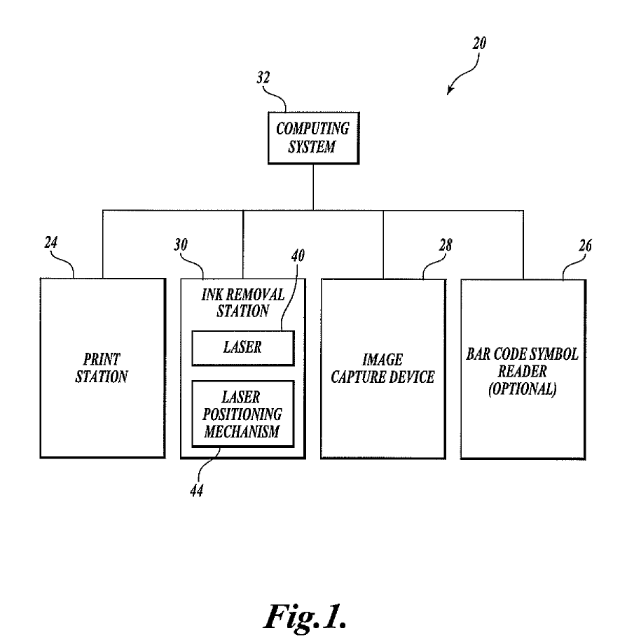

Turning now to FIG. 1, there is shown a block diagram of one exemplary embodiment of a system for improving the readability of printed bar code symbols, generally designated 20, formed in accordance with aspects of the present invention. As best shown in FIG. 1, the system 20 includes a print station 24 for printing at least one bar code symbol B onto a selected substrate S, an optional bar code symbol reader 26 for determining whether the printed bar code symbol is readable, an image capture device 28 for capturing a digital image of the printed bar code symbol, an ink removal station 30 having a laser 40 for removing a portion of the printed bar code symbol, and a computing system 32. As will be described in more detail below, the computing system 32 includes an image analysis module for analyzing the images captured by the image capture device 28. Based on the results of the analysis of the captured image, the system 20 improves the readability of the printed bar code symbol by removing ink from the printed bar code symbol representative of potential deficiencies caused, in part, by the printing methods employed.

Referring again to FIG. 1, the components of the system 20 will be described in more detail. The print station 24 may utilize any conventional digital printing apparatus, such as an inkjet printer, wide format inkjet printer or plotter, electrophotographic toner printer, etc., or any analog printing apparatus that uses contact methods, such as a flexographic, gravure, lithographic, screen, letterpress, etc, for printing ink in the form of at one bar code symbol onto a selected substrate. In several embodiments, the selected substrate is a label that may be affixed to packaging, etc., for purposes of inventory tracking, etc. In other embodiments, the selected substrate is one typically utilized in the shipping, packaging, and display packaging industries. Examples of such substrates utilized in the shipping, packaging, and display packaging industry include but are not limited to envelopes, fiberboard, box board, combined board, corrugated fiberboard, paperboard, etc. In these embodiments, it will be appreciated that other images, such as branding marks, graphics, and other marketing type information, may also be printed onto the substrate prior to, contemporaneously with, or subsequent to printing of the bar code symbol.

In operation, the selected substrate may be advanced to or otherwise placed in an appropriate position at the print station 24 either manually or via any conventional automated feeder/conveyance means known in the alt. In several embodiments, advancement of the substrate may be controlled by the computing system 32. In embodiments where the substrate is in web form, the conveyance means may include conventional motorized rollers (not shown), the operation of which may be controlled by the computing system 32. It will be appreciated that other conventional components may be utilized by the print station 24 including, but not limited to, position sensors, substrate alignment structure, etc. Once properly positioned, the print station printing apparatus prints one or more layers of ink onto the substrate in the form of one or more bar code symbols.

In order to increase the throughput of the system 20, the system 20 may further includes a bar code symbol reader 26. The bar code symbol reader 26 may be a stand alone unit or may be connected in electrical communication (wired or wireless) with the computing system 32. The bar code symbol reader 26 may be located at the print station 24, a separate station, or at another processing station within the system 20. In these embodiments, the operation of the bar code symbol reader may be automated by the system. Alternatively, the bar code symbol reader 26 may be a handheld device that is operated by personnel at the processing plant. The bar code symbol reader 26 scans the bar code symbol printed on the substrate and determines whether the printed bar code symbol is readable or not. If it is determined that the bar code symbol is readable, the substrate may be further transferred either manually or by any conventional conveyor systems for further processing. Further processing may include but is not limited to scoring, cutting, folding, gluing, etc., in order to form the final product. If it is determined that the bar code symbol is not readable, an error signal is generated, and as a result, the substrate is advanced to a position associated with the image capture device 28. In embodiments where more than one bar code symbol is printed onto the substrate, the system 20 may correspondingly include more than one bar code reader.

The bar code symbol reader 26 may be any conventional or future developed bar code symbol reader, such as a bar code laser scanner or a bar code image capture device, that includes a sensor that is capable of generating electrical signals from capturing the bar code symbol and a decoder that decodes the electrical signals and analyzes the content of the captured bar code symbol. In embodiments of the present invention, the bar code symbol that is captured and decoded by the bar code reader 26 may be one dimensional, two dimensional, or any future developed bar code symbol. The bar code reader 26 may also transmit data to the computer system 32 indicative of the bar code symbol in a traditional format. In one embodiment, the bar code reader 26 may be configured for determining whether the printed bar code symbol is readable or not. Alternatively, the computing system 32 may be configured for making such determination from the data transferred thereto by the reader 26. In either case, a signal is generated that indicates whether the printed bar code symbol is or is not readable.

The computing system 32 may use the generated signals for keeping track of the number of unreadable printed bar code symbols. If the number reaches a predetermined threshold during the production run or if the ratio of unreadable to readable reaches a predetermined threshold, an alert may be generated by the computing system 32. The alert may include an automatic page, a telephone or cellular phone call, an e-mail, or other means for notifying an operator that is located either locally or remote from the system 20. It may also include an audible signal, such as a horn or buzzer, a visible signal, such as a flashing red light, etc. Further, the alert could shut down the print station until operator input is obtained. It may also cause the operator to manually check the equipment, such as the bar code reader 26 or print station 24.

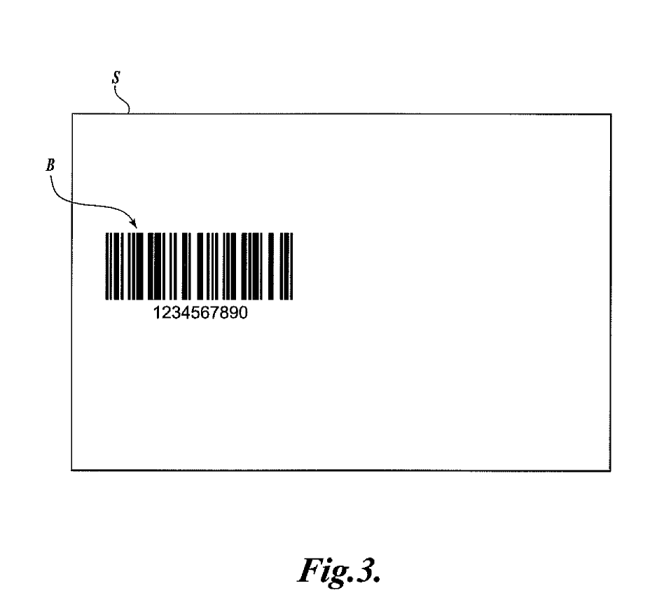

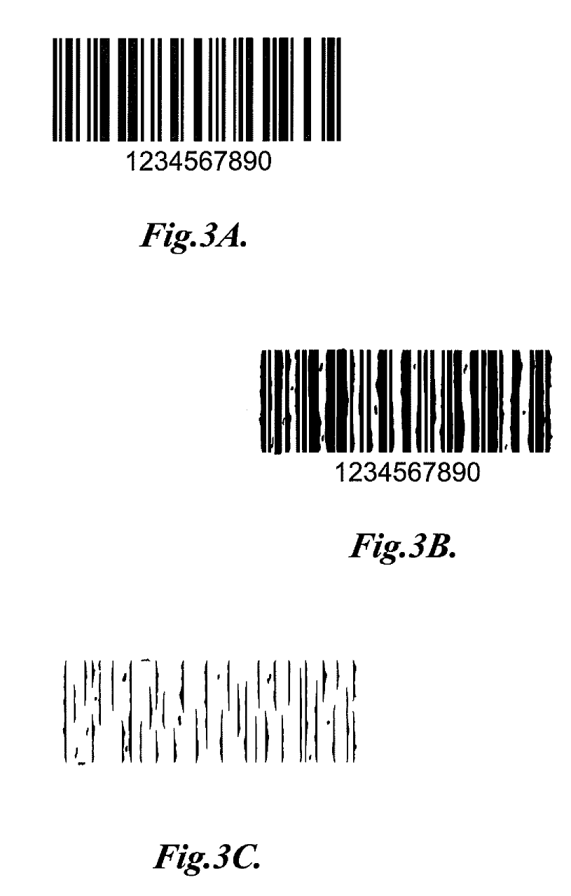

The system 20 further includes at least one image capture device 28 for capturing printed image data, for example, of the printed bar code symbol, which was printed onto the substrate by the print station 24. FIG. 3 is a top view of a substrate S depicting one embodiment of a one-dimensional bar code symbol B printed thereon. As shown in FIG. 3B, the printed bar code symbol includes deficiencies that may affect the readability of the bar code symbol by conventional bar code scanner devices. In this example, the deficiencies include satellite drops, ink squeeze-out at the trailing and leading edges, etc. These may be caused by the specific type of printing, e.g., digital ink jet, flexography, etc.

As is known in the art, bar code symbols can be unreadable for many reasons. For example, the bars may not be at the correct spacings, the bars may not have the correct widths, or in the case of two dimensional bar code symbols, the bars may not have the correct vertical heights, contrast between bars and spaces may not be suitable, spaces may contain printed objects, etc. These problems can be caused by many different reasons during the printing process, such as misregistration, faulty ink jet heads, worn printing plates, insufficient ink transfer, etc.

The image capture device 28 is disposed in a suitable position and orientation for capturing the printed bar code symbol B from the substrate S. It should be appreciated that the image capture device 28 can be located either with the print station 24 or the ink removal station 30, or can be located discrete from either the print station or the ink removal station 30, such as being part of a separate image capture station. Alternatively, the image capture device 28 may be associated with other processing equipment.

The image capture device 28 is electrically connected (e.g., wired or wireless) to the computing system 32 for receiving signals from the computing system 32 for capturing the image when the substrate is in a suitable position and for sending digital image data of the captured image to the computing system 32 for processing. The image capture device 28 may be any conventional single device or collection of multiple devices that captures images of the print data, such as the bar code symbol, upon receipt of a control signal, and generates digital image data to be transferred to the computing system 32 for image analysis. Examples of the image capturing device 28 may include, but are not limited to, CCD sensors, CMOS sensors, digital cameras, and scanners. It will be appreciated that light sources or other conventional components that may aid in the image capture of print data may be used.

The system 20 further includes an ink removal station 30. The ink removal station 30 includes any conventional laser assembly suitable for use in the packaging (e.g., containerboard, fiberboard, etc.) industry that utilizes at least one laser 40 having a selectively adjustable power output level and pulse characteristics. In embodiments where multiple bar code symbols are printed on the substrate, multiple lasers may also be used to more rapidly and simultaneously process the multiple bar codes printed on the substrate. In some embodiments, the multiple lasers may be positioned so they operate on different sides of the substrate, especially if the substrate is, for example, a side-sealed box blank or fully formed box. In these embodiments, the system 20 may further include additional image capture devices 28 for viewing the different sides simultaneously and capturing the images of the multiple bar code symbols.

In one embodiment, the ink removal station 30 further comprises a frame (not shown) and a platen or bed (not shown) for supporting the substrate as the laser removes ink in undesirable locations on the substrate by the laser 40. The platen is supported in a stationary manner by the frame and is constructed in a conventional manner One or more lasers 40 may be suspended a spaced distance above the platen by one or more laser positioning mechanisms 44. The laser positioning mechanism 44 may be a robot arm, a mechanical 2D positioning mechanism, such as an XY table, or like structure. The laser positioning mechanism 44 may also include one or more mirrors (not shown) for directing the laser light to the desired locations on the substrate surface. These mirrors may be galvanometrically controlled as is known in the art. The laser positioning mechanism 44 is configured and arranged for moving the laser 40 at a selectively adjustable speed (laser cutting speed) in the X and Y planes with respect to the supported substrate.

In operation, a sheet of substrate, such as substrate S, having a printed bar code symbol, such as printed bar code symbol B, is placed into position on the platen of the ink removal station 30 and held in place. For example, the sheet of substrate may be placed into the appropriate position on the platen of the ink removal station 30 either manually or via any automated feeder/conveyance means known in the art. The laser 40 then removes or ablates ink at selected locations from the printed bar code symbol according to control signals received from the computing system 32. As will be described in more detail below, the control signals are generated according to data generated by the image analysis module, such as a mask file, and stored in system memory. The mask file includes data representative of ink removal locations for the particular printed bar code symbol.

It will be appreciated that other conventional components may be utilized by the ink removal station 30, including but not limited to position sensors, encoders, etc. The position sensors can be used to determine the position of the substrate prior to and during the ink removal process while the encoders can be used to determine the position of the laser with respect to the substrate during the ink removal process. Additionally, it will be appreciated that the ink removal station 30 may be combined with or used as a cutting station for cutting score lines, cut-outs, and the overall shape of substrate blanks. In embodiments that utilize the laser 40 for such additional operations, it will be appreciated that the power levels are adjusted for achieving the desired type of cut.

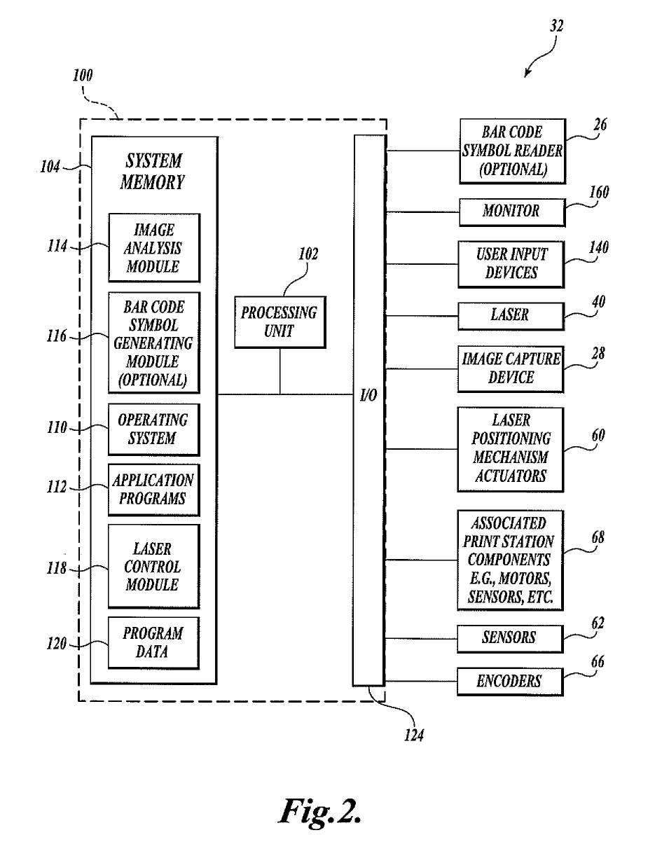

As described briefly above, the optional bar code symbol reader 26, the image capture device 28, the ink removal station 30, and, optionally, the printing station 24, are controlled by the computing system 32. One embodiment of the computing system 32 is illustrated as a block diagram in FIG. 2. Although not required, aspects of the present invention may be described in the general context of computer-executable instructions, such as program modules, being executed by a personal computer or computing device and stored, for example, on computer readable media, as will be described below. Generally, program modules include routines, programs, objects, components, data structures, etc., that perform particular tasks or implement particular abstract data types.

The computing system 32 includes a computing device 100, including a processing unit 102 and system memory 104 suitably interconnected. The system memory 104 may include read only memory (ROM), random access memory (RAM), and storage memory. The storage memory may include hard disk drives for reading from and writing to a hard disk, a magnetic disk drive for reading from or writing to a removable magnetic disk, and an optical disk drive for reading from or writing to a removable optical disk, such as a CD, DVD, or other optical media. The storage memory and their associated computer-readable media provide non-volatile storage of computer readable instructions, data structures, program modules, and other data for the computing system 32. Other types of computer readable media which can store data that is accessible by a computer, such as magnetic cassettes, flash memory cards, digital video disks, Bernoulli cartridges, random access memories (RAMs), read only memories (ROMs), and the like, may also be used in the exemplary computing system.

A number of program modules may be stored on the system memory 104, including an operating system 110, one or more application programs 112, an image analysis module 114, an optional bar code symbol generating module 116, a laser control module 118, and program data 120, such as image files including reference bar code symbols, reference bar code symbol specifications, print files, etc., optional laser cut files, and printer error data. In several embodiments that utilize digital printing apparatuses, the application programs 112 may include desktop publishing programs, such as Adobe Photoshop®, Adobe Illustrator®, and/or Adobe PageMaker®. Other program modules that may be stored in memory 104 include color ink jet print drivers and/or printing preparation programs.

The print drivers and/or printing preparation programs are capable of generating print command signals that upon reception from the printer causes the printer to print the desired image. The print drivers and/or printing preparation programs may work in conjunction with the processing unit 102 to form a raster image processor (RIP). Alternatively, the computing system 32 may include an image conversion module as part of or separate from the desktop publishing program, which works in conjunction with the processing unit 102 to form the raster image processor (RIP). The term desktop publishing program is used herein to include all programs, such as image processing programs, image creation programs, raster image processing, page creation programs, that are employed, for example, in the desktop publishing, graphic arts, or engineering drawing industries.

The image analysis module 114 is capable of analyzing the printed bar code symbol that is captured by the image capture device 28. In operation, the image analysis module 114 in one embodiment compares the image of the printed bar code symbol obtained by the image capture device 28 to a reference bar code symbol image. The reference bar code symbol could be an image of an acceptable bar code symbol having the desired identification (e.g., bar code numbers and/or letters). The reference bar code symbol may be pre-stored in system memory 104 or can be generated by the optional bar code symbol generating module 1.16 according to data, such as the numbers/letters, inputted by the operator via user input devices 140. In other embodiments, the image analysis module 114 compares the image of the printed bar code symbol obtained by the image capture device 28 to a series of reference bar code symbol specifications. The series of specifications may comprise but are not limited to dimensions of the bars, spaces, contrast values of printed to unprinted areas, printed objects (spots) within unprinted spaces, printed edge roughness, etc. to fully define an acceptable bar code symbol having the desired identification. These specifications may be pre-stored in system memory 104 or can be generated by the optional bar code symbol generating module 116, as described above.

The image analysis module 114 may use any conventional image analysis techniques for comparing the printed bar code symbol to the reference bar code symbol or the reference bar code symbol specifications. Examples of image analysis techniques that may be used include but are not limited to intensity level thresholding, wavelet filtering, frequency filtering, noise filtering, color component filtering, image registration, template matching, correlation, etc. The comparison of the printed bar code symbol and the reference bar code symbol/specifications results in the generation of a mask file, or a file that contains data indicative of the location of ink present in the printed bar code symbol that is not present in the reference bar code symbol/specifications.

As will be described in more detail below, the mask file may optionally be further analyzed and processed to selectively determine those objects which do not affect the bar code readability. These objects could be identified using any conventional image analysis techniques, including but not limited to intensity level, size, shape and/or location thresholding, wavelet filtering, frequency filtering, noise filtering, etc. These objects, which are inconsequential to bar code readability, may then be removed from the mask file to create a revised, or optimized, mask file to be executed by the laser control module 118, as described further below. The final mask file to be executed is outputted by the image analysis module 114 and saved in system memory 104.

The laser control module 118 is capable of generating appropriate control signals for operating the laser assembly upon reception of the mask file generated by the image analysis module 114. The generated control signals, when received by the laser assembly, causes the laser 40 to be moved to the appropriate position by the laser positioning mechanism 44 and operated for removing or ablating the printed ink from the printed bar code symbol corresponding to the location data contained in the mask file.

The computing system 32 is connected in electrical communication with motor(s) or actuators 60 of the laser positioning mechanism 44, position sensors 62, encoders 66, and motors of the conveyance means, if desired, via input/output circuitry 124 or other device level circuitry. The input/output circuitry or other device level circuitry are capable of receiving, processing, and transmitting appropriate signals between the processor and the sensors, encoders, motors, etc. The actuators 60 of the laser positioning mechanism 44, the position sensors 62, and the encoders 66 are capable of controlling the positioning of the laser 40 during the ink removal process. The computing system 32 further is connected in electrical communication with the laser 40 of the ink removal station 24 via the I/O circuitry 124. One such laser that may be practiced with the present invention is the Synrad FH Series “Index” Marking Head with firestar v30 laser, commercially available from Synrad, Inc., Mukilteo, Wash.

The computing system 32 is optionally connected in electrical communication with associated components 68, e.g., motor(s), position sensors, actuators, etc. of the print station 24 via input/output circuitry 124 or other device level circuitry. The input/output circuitry 124 or other device level circuitry is capable of receiving, processing, and transmitting appropriate signals between the processing unit and the various components. If utilizing a digital printer, the computing system 32 may be further connected in electrical communication with the digital printer via the I/O circuitry 124. One digital printer that may be practiced with the present invention is the Rhopac digital printer, commercially available from Durst Phototechnik Digital Technology GmbH, Lienz, Austria.

The computing system 32 may further include user input devices 140, such as a keyboard, a pointing device, or the like, for inputting data, such as bar code numbers and/or letters, into the computing system 32. The user input devices 140 are suitably connected through appropriate interfaces, such as serial ports, parallel ports or a universal serial bus (USB) of the I/O circuitry. A monitor 160 or other type of display device may also be included.

Examples of methods for improving the readability of printed bar codes will now be described with reference to FIGS. 1-6. The process 200 begins at block 202 by advancing a sheet or web of substrate to the print station 24. For example, if using discrete sheets of substrate, the substrate is first transferred one at a time to the print station either manually, or via an automated system comprised of, for example, conventional infeeders/conveyance means. On the other hand, if the substrate stock is in web form, the web of substrate stock may be advanced through the print station via motorized rollers, also well know in the art. In either case, it will be appreciated that the computing system 32 may optionally generate and output appropriate control signals for controlling the advancement of the substrate.

Next, at block 204, at least one layer of ink is printed onto the substrate 26 at the print station in the form of a desired bar code symbol B. In embodiments that utilize analog printing devices, such devices apply the ink to the substrate in accordance with, for example, prefabricated printing plates having the desired bar code symbol. In embodiments that utilize digital inkjet printing devices, such devices apply the ink to the substrate according to the print signals sent thereto via the computing system 32 and, for example, generated by the raster image processor. It will be appreciated that the bar code symbol B may be printed using any one of a combination of ink colors, including but not limited to cyan (C), yellow (Y), magenta (M), and black (K). In embodiments of the present invention, the bar code symbol B may be a one dimensional bar code symbol, a two dimensional bar code symbol, or future developed bar code symbol.

If the system 20 includes the optional bar code symbol reader 26, the process then proceeds to block 206, where the substrate is transferred to a suitable position with respect to the bar code symbol reader 26 for capturing the printed bar code symbol. It will be appreciated that the substrate may be transferred manually or via automated systems, and that the transfer may be as simple as moving the substrate to another location on the print station or moving the substrate to either a discrete image capture station or other processing station. Alternatively, the reader 26 may be a portable device that an operator uses to capture the bar code symbol anytime after it is printed.

The process then proceeds to block 208, where a determination is made whether or not the printed bar code symbol is readable. If it is determined by the reader or reader/computing system that the bar code symbol is readable, the process proceeds to block 210, where the substrate may be further transferred either manually or by any conventional conveyor systems for further processing. For example, if the reader 26 or the computing system 32 determines that the printed bar code is readable from the scan, an appropriate signal is generated that controls the subsequent transfer of the substrate to other optional processing stations. Further processing may include but is not limited to scoring, cutting, folding, gluing, etc., in order to form the final product.

On the other hand, if it is determined that the printed bar code symbol B is not readable, the process proceeds to block 212, where the substrate is transferred to a suitable position with respect to the image capture device 28 for capturing a digital image of the printed bar code symbol B. It will be appreciated that the substrate may be transferred manually or via automated systems, and that the transfer may be as simple as moving the substrate to another location on the print station or moving the substrate to either a discrete image capture station or other processing station. Next, at block 214, a digital image of the printed bar code symbol B is captured by the image capture device 28.

Once the printed bar code symbol B is captured by the device 28 at block 214, the process 200 proceeds to block 216 where the captured image is transferred to the computing system 32 for analysis. For example, once the printed bar code symbol B is captured, the digital data representing the captured image is transferred to the computing system 32 where it is analyzed by the image analysis module 114, as will be described in more detail below. The image analysis module 114 determines whether deficiencies in the printed bar code symbol are present that would potentially affect the readability thereof. The image analysis module 114 may use any conventional image analysis techniques for analyzing the captured printed bar code symbol. Examples of image analysis techniques that may be used include, but are not limited to, intensity level thresholding, wavelet filtering, frequency filtering, noise filtering, color component filtering, image registration, template matching, correlation, etc.

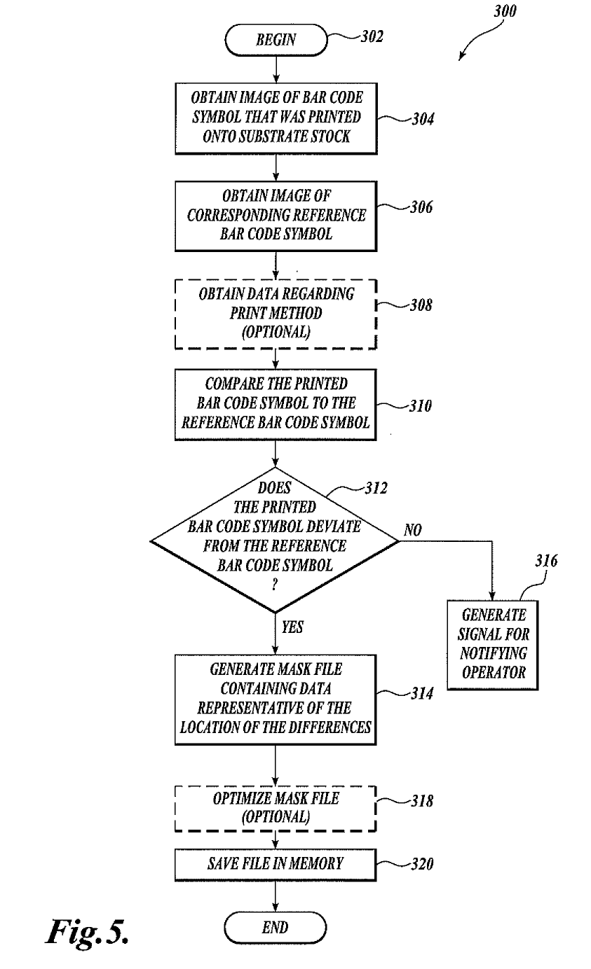

Turning now to FIG. 5, there is shown a block diagram of one exemplary image analysis routine 300 executed by the image analysis module 114 that may be practiced with the present invention. The routine 300 begins at block 302 and proceeds to block 304, where the digital image of the printed bar code symbol B captured by the image capture device 28 is obtained from system memory 104. One such printed bar code symbol is shown in FIG. 3B. The routine 300 continues to block 306 where a reference bar code symbol image is obtained from system memory 104. The obtained reference bar code symbol image corresponds to the printed bar code symbol B and is representative of a printed bar code symbol that is readable by a standard bar code reader. One such reference printed bar code symbol is shown in FIG. 3A.

It will be appreciated that the image analysis module 114 may obtain information inputted by the user and stored in system memory regarding identification data (e.g., the number and/or letter pattern) of the bar code symbol to be printed so that an appropriate reference bar code symbol is obtained. Alternatively, the reference bar code symbol may be generated by the bar code generating module 116 based upon data, such as bar code numbers/letters, inputted by the operator via the user input devices 140, and then stored in system memory 104.

Next, at block 310, the obtained image of the printed bar code symbol B is compared to the reference bar code symbol obtained from the memory 104 for determining the potential deficiencies of the printed bar code symbol. In several embodiments, the image analysis module 114 compares pixel by pixel the entire image or pixel by pixel of a selected region. In these latter embodiments, additional information may be inputted by the operator that may aid the module 114 in its analysis, as will be further described below.

In several embodiments of the present invention, information regarding the method of printing at the print station may be obtained. To that end, in an optional step of the process 200, information about the printing method is inputted into the computing system 32 at block 308. This information can either be selected from an on-screen menu or can be entered via the user input devices as, for example, a reference number that is associated with the printing method. For example, if the print station utilizes a flexographic printer, the user can enter data into the computer system by selecting “flexography” from a menu displayed on display 160, or by entering a reference code associated with that specific printing method. Based on the data inputted into the computing system 32 at block 308, printing error data is obtained from system memory 104 that corresponds to the type of printing method. For example, digital ink jet printers are known to leave satellite drops in the spaces between the bars and at the edges of the bars. Accordingly, in this example, the image analysis module 114 can utilize this additional information for focusing on specific regions of the bar code that may be more susceptible to printing errors.

Returning now to block 310, each pixel of the image of the printed bar code symbol, shown in FIG. 3B, is compared to the corresponding pixel location of the reference image shown in FIG. 3A. The routine 300 then proceeds to block 312, where a determination is made as to whether the printed bar code symbol deviates from the reference bar code symbol. For example, a determination can be made as to whether, pixel by pixel of a region or of the entire image, a deviation exists between the printed bar code symbol and the reference bar code symbol.

If it is determined at block 312 that the printed bar code symbol deviates from the reference bar code symbol, the routine proceeds to block 314, where a mask file is generated. The mask file includes data that represents only the differences in the images, which is shown in FIG. 3C. As such, the mask file typically represents the deficiencies in the printing process that potentially caused the error in reading at the optional reader stage. Next, at block 320, the mask file is stored in system memory 104 to be accessed by the laser control module 118. On the other hand, if it is determined that no discernable deviations exist, then the process proceeds to block 316, where the operator is notified by an appropriate generated signal for operator action, such as a manual check.

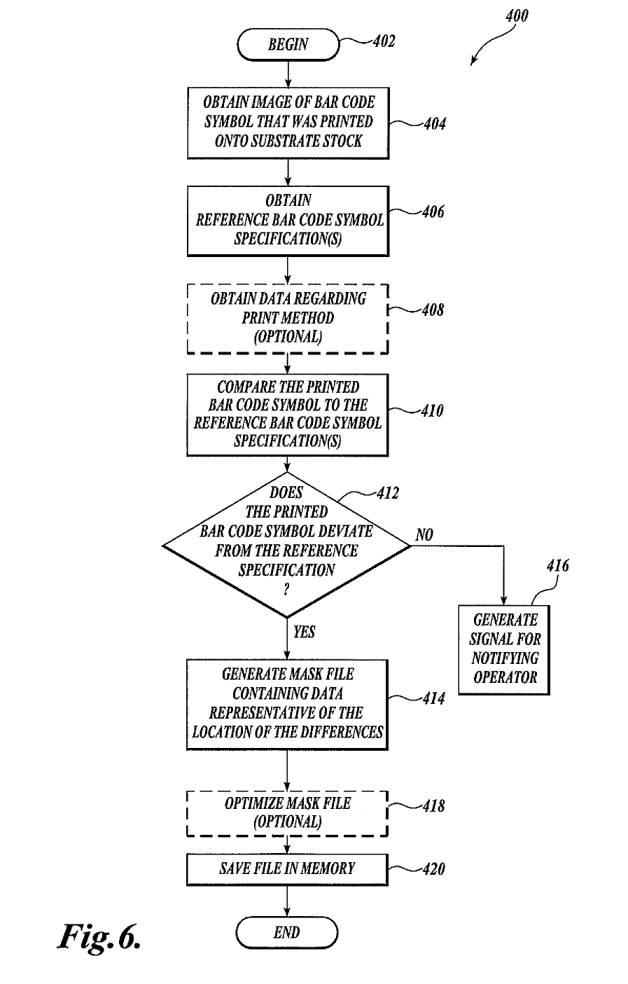

Turning now to FIG. 6, there is shown a block diagram of another exemplary image analysis routine 400 executed by the image analysis module 114 that may be practiced with the present invention. The routine 400 begins at block 402 and proceeds to block 404, where the digital image of the printed bar code symbol B captured by the image capture device 28 is obtained from system memory 104. One such printed bar code symbol is shown in FIG. 3B. The routine 400 continues to block 406 where specifications indicative of a reference bar code symbol are obtained from system memory 104. The obtained reference bar code symbol specifications correspond to information contained in printed bar code symbol B and is representative of specifications for a printed bar code symbol that is readable by a standard bar code reader. These specifications may include but are not limited to ideal and tolerance numerical values or other data for printed areas, space areas, printed to unprinted contrast, printed objects (spots) within unprinted spaces, printed edge roughness, etc.

It will be appreciated that the image analysis module 114 may obtain information inputted by the user and stored in system memory 104 regarding identification data (e.g., the number and/or letter pattern) of the bar code symbol to be printed so that appropriate reference bar code symbol specifications are obtained from system memory 104. In other embodiments, the reference bar code specifications may be generated by the bar code generating module 116 based upon data, such as bar code numbers/letters, inputted by the operator via the user input devices 140, and then stored in system memory 104. In yet other embodiments, the specifications for the reference bar code symbol may be manually entered by the operator via the user input devices 140, and then stored in system memory 104.

Next, at block 410, the obtained image of the printed bar code symbol B is compared to the reference bar code specifications obtained from the memory 104 for determining the potential deficiencies of the printed bar code symbol B. In this embodiment, the image analysis module 114 compares, for example, numerical values of characteristics (e.g., printed to unprinted contrast, bar widths and spacing, etc.) of printed bar code symbol object areas (e.g., printed bars and unprinted spaces for a one-dimensional bar code) to the corresponding reference bar code specifications. These numerical values are obtained by appropriate analysis of the printed bar code symbol B.

In several embodiments of the present invention, information regarding the method of printing at the print station may be obtained. To that end, in an optional step of the process 200, information about the printing method is inputted into the computing system 32 at block 408. This information can either be selected from an on-screen menu or can be entered via the user input devices as, for example, a reference number that is associated with the printing method. For example, if the print station utilizes a flexographic printer, the user can enter data into the computer system by selecting “flexography” from a menu displayed on display 160, or by entering a reference code associated with that specific printing method. Based on the data inputted into the computing system 32 at block 408, printing error data is obtained from system memory that corresponds to the type of printing method. For example, digital inkjet printers are known to leave satellite drops in the spaces between the bars and at the edges of the bars. Accordingly, in this example, the image analysis module 114 can utilize this additional information for focusing on specific regions of the bar code that may be more susceptible to printing errors.

Returning now to block 410, a comparison is made between the printed bar code symbol B and the reference bar code specifications. The routine 400 then proceeds to block 412, where a determination is made as to whether the printed bar code symbol deviates from the reference bar code symbol specifications. In comparing the printed bar code symbol to the reference specifications, the entire bar code symbol and/or the individual bar code symbol areas (e.g., horizontal rows, etc.) are compared to determine deviations. For example, a determination can be made as to whether a deviation exists between, for example, dimensional values calculated by the image analysis module 114 of a printed bar or space widths of the printed bar code symbol B and the reference specifications.

If it is determined at block 412 that the printed bar code symbol deviates from the reference bar code symbol specifications, the routine proceeds to block 414, where a mask file is generated. The mask file includes data that represents only the differences in the images. As such, the mask file typically represents the deficiencies in the printing process that potentially caused the error in reading at the optional bar code reader stage.

Next, at block 420, the mask file is stored in system memory 104 to be accessed by the laser control module 118. On the other hand, if it is determined that no discernable deviations exist, then the process proceeds to block 416, where the operator is notified by an appropriate generated signal for operator action, such as a manual check.

In accordance with aspects of the present invention, additional analysis and processing of the mask file may be conducted by either routine 300 or routine 400 at blocks 318 and 418, respectively. Such additional analysis and processing could interpret the mask to identify the areas of difference that significantly impact bar code readability. For instance, some satellite drops may be too small or randomly spaced to affect bar code readability. As such, these inconsequential drops would not need to be removed by the laser. However, grouped or large satellite drops can affect bar code readability and could be targeted for removal. This also applies to one-dimensional bar code width, where some growth is permissible, and height, which is not important in a one-dimensional bar code symbol. Two-dimensional bar code symbols have redundant features, so some mask areas may show differences that do not render the bar code symbol unreadable. These deficiencies could be ignored to improve laser processing time without sacrificing bar code readability. Accordingly, the mask file can be optimized in this manner and save in system memory 104 to be accessed by the laser control module 118. By optimizing the mask file the laser processing time can be reduced.

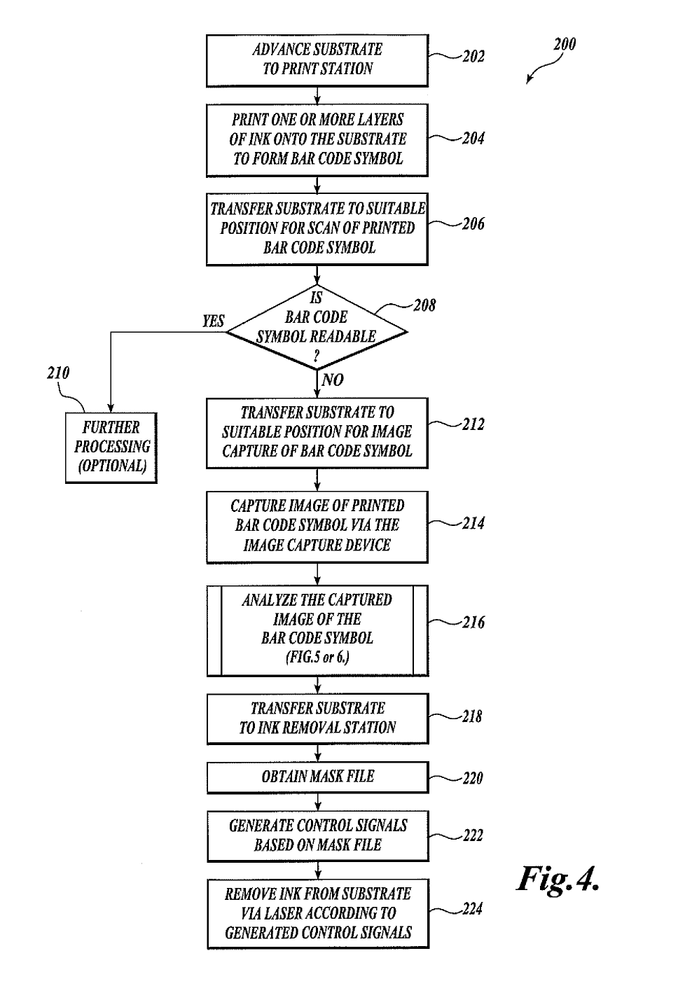

After the captured image is analyzed at block 216, for example, according to either the routine 300 or routine 400, the process 200 proceeds to block 218 shown in FIG. 4, where the substrate is advanced to the ink removal station 30 and the substrate is placed into an appropriate position. The substrate can be placed into the ink removal station 30 either manually, or via an automated system comprised of, for example, conventional conveyance means. Next, at block 220, the mask file, or optionally, the optimized mask file, is obtained and read by the laser control module 118. The laser control module 118 then generates at block 222 the appropriate control signals based on the mask file and transmits the control signals to the laser assembly. Upon receipt of the control signals by the laser assembly, the laser 40 is moved to the appropriate locations by the laser positioning mechanism 44 and operated to remove ink from the printed bar code symbol at block 224.

After the substrate is processed at the ink removal station 30, the substrate may be further transferred either manually or by any conventional conveyor systems for further processing. Further processing may include but is not limited to printing, scoring folding, gluing, etc. in order to form the final product. It will be appreciated that the substrate may be pre-processed prior to being placed into the ink removal station 30. Such pre-processes include but are not limited to printing, scoring, gluing, folding, cutting, coating, etc. It will be further appreciated that the printed bar code symbol may be transferred to an appropriate location for testing the readability of the processed printed bar code symbol by the bar code reader 26 or other bar code reader.

The principles, representative embodiments, and modes of operation of the present invention have been described in the foregoing description. However, aspects of the present invention which are intended to be protected are not to be construed as limited to the particular embodiments disclosed. Further, the embodiments described herein are to be regarded as illustrative rather than restrictive. Variations and changes may be made by others, and equivalents employed, without departing from the spirit and scope of the present invention. Accordingly, it is expressly intended that all such variations, changes, and equivalents fall within the spirit and scope of the present invention, as claimed.

1. A method for improving the readability of a printed bar code symbol, comprising:
printing material onto a substrate in the form of a bar code symbol;
capturing an image of the printed bar code symbol;
analyzing the captured image of the printed bar code symbol for determining one or more printing errors;
removing material representing at least a portion of the one or more printing errors from the substrate.

2. The method of claim 1, wherein analyzing the captured image includes:
(a) obtaining a reference bar code symbol;
(b) comparing the reference bar code symbol to the captured image of the printed bar code symbol;
(c) generating data indicative of the differences between the reference bar code symbol and the captured image of the printed bar code symbol, the differences representing at least a portion of the printing errors.

3. The method of claim 2, wherein the reference bar code symbol is obtained from memory of a computing system or generated by a bar code symbol generator.

4. (canceled)

5. The method of claim 1, wherein analyzing the captured image includes:
(a) obtaining at least one reference bar code symbol specification;
(b) comparing the reference bar code symbol specification to the captured image of the printed bar code symbol;
(c) generating data indicative of the differences between the reference bar code symbol specification and the captured image of the printed bar code symbol, the differences representing at least a portion of the printing errors.

6. The method of claim 5, wherein the at least one reference bar code symbol specification is selected from the group consisting of bar widths, space width, and contrast between printed and unprinted areas.

7. The method of claim 5, wherein the reference bar code symbol is obtained from memory of a computing system or generated by a bar code symbol generator.

8. (canceled)

9. The method of claim 1, wherein the printing errors are removed by a laser.

10. The method of claim 1, further including:
capturing the printed bar code symbol to determine its readability.

11. The method of claim 1, wherein analyzing the captured image comprises:
(a) comparing the printed bar code symbol to a reference bar code symbol or symbol specifications;
(b) determining the differences between the printed bar code symbol and the reference bar code symbol or symbol specifications, the differences being at least one of the printing errors;
(c) generating instructions to be read by a laser for removing a portion of the printed bar code symbol that corresponds to at least one of the printing errors.

12. The method of claim 11, further comprising
determining which of the differences between the printed bar code symbol and the reference bar code symbol or symbol specifications is least likely to affect bar code symbol readability and omitting such data from the instructions outputted to the laser.

13. A method for improving the readability of a printed bar code symbol, comprising:
capturing an image of a printed bar code symbol;
analyzing the captured image of the printed bar code symbol for determining printing errors by:
(a) obtaining a reference bar code symbol or reference bar code symbol specification;
(b) comparing the reference bar code symbol or reference bar code symbol specification to the captured image of the printed bar code symbol;
(c) generating data indicative of the differences between the reference bar code symbol or reference bar code symbol specification and the captured image of the printed bar code symbol, the differences representing at least a portion of the printing errors;
removing at least a portion of the printing errors from the substrate based on the generated data.

14. The method of claim 13, further comprising printing at least one bar code symbol onto a substrate.

15. A system for improving the readability of a printed bar code symbol, comprising:
an image capture device capable of capturing a digital image of a printed bar code symbol from a substrate;
a laser capable of removing a portion of the printed bar code symbol; and
a computing system capable of
(1) receiving the captured image of the bar code symbol;
(2) comparing the image to a reference bar code symbol image or a reference bar code symbol specification for determining the differences therebetween; and
(3) outputting suitable signals to the laser for operating the laser to remove a portion of the printed bar code symbol associated with the differences previously determined.

16. The system of claim 15, further comprising a printer capable of printing the bar code symbol onto the substrate.

17. The system of claim 15, wherein the reference bar code symbol or symbol specification is obtained from memory of a computing system.

18. The system of claim 15, wherein the reference bar code symbol or symbol specification is generated by a bar code symbol generator.

19. The system of claim 15, wherein the reference bar code symbol or symbol specification is inputted into the computing system by an operator.

20. The system of claim 15, wherein the computing system is capable of determining which of the differences between the printed bar code symbol or symbol specification and the reference bar code symbol or symbol specifications is least likely to affect bar code symbol readability and omitting such data from the signals outputted to the laser.

21. The system of claim 15, wherein the computing system uses printing method data when comparing the image.

22. The method of claim 1, further comprising
obtaining printer method data; and
using the printer method data when analyzing the captured printed barcode symbol.
